(19) United States
(12) Patent Application Publication
(10) Pub. No.: US 2005/0279708 A1
(43) Pub. Date: Dec. 22, 2005

(54) Method for separating organic acid from a hydroperoxide stream

(76) Inventors: Johannes Leendert Willem Cornelis Den Boestert, Amsterdam (NL); Anke Derking, Amsterdam (NL); Frank Haiko Geuzebroek, Amsterdam (NL); Raymond Lawrence June, Singapore (SG)

Correspondence Address: Jennifer D. ADAMSON;Shell Oil Company, Legal-Intellectual Property, P.O. Box 2463, Houston, TX, 77252-2463, US

(21) Appl. No.: 11/003,315

(22) Filed: Dec. 3, 2004

(30) Foreign Application Priority Data
Dec. 3, 2003 (SG) 200307187-5

(51) Int. Cl. B01D 11/00; B01D 11/04

(52) U.S. Cl. 210/634; 210/644; 210/749; 210/651

(57) ABSTRACT

The invention relates to a method for separating organic acid from an organic hydroperoxide stream by bringing the hydroperoxide stream into contact with an extraction fluid, in which process the extraction fluid and the hydroperoxide stream are separated from each other by a membrane.

### FIELD OF THE INVENTION

The invention relates to a method for separating organic acid from an organic hydroperoxide stream by bringing the hydroperoxide stream into contact with an aqueous extraction fluid.

### BACKGROUND OF THE INVENTION

Known methods for separating organic acids from organic hydroperoxides are currently used to prevent corrosion problems in process equipment and deactivation of catalysts. Such known methods comprise liquid-liquid extraction of acids from a hydroperoxide stream. For instance, in U.S. Pat. No. 5,883,268 a method for obtaining a purified ethyl benzene hydroperoxide stream, useful for the solid heterogeneous catalyst catalyzed reaction with propylene to form propylene oxide includes contacting a crude ethyl benzene hydroperoxide stream obtained by peroxidation of ethyl benzene with an aqueous solution of an alkali metal base, and separating the resulting mixture into an aqueous stream and a deacidified organic stream; contacting said stream with water, and separating the resulting mixture into an organic-contaminated water phase and an organic phase having a reduced alkali metal content; and contacting the organic-contaminated water phase with an extractive hydrocarbon, selected from ethyl benzene, benzene, cyclohexane, and alkanes, and separating the resulting mixture into a purified water phase having a reduced level of organic contaminants or into an organic-contaminated water phase and an organic phase consisting of hydrocarbon extractant and organic impurities from the organic-contaminated water phase.

However, such known methods make use of caustic extraction steps, usually leading to severe caustic hydroperoxide emulsion formation, which is the cause of many problems such as equipment corrosion, operational instability, and increased catalyst consumption in subsequent steps. Furthermore, a relatively expensive settling step is necessary using additional equipment to settle the caustic emulsion.

Therefore, there is a need for a method for obtaining a purified organic hydroperoxide stream by removing organic acid from an organic hydroperoxide stream, which is devoid of the hereinbefore-mentioned disadvantages.

### SUMMARY OF THE INVENTION

The invention is directed to a method of removing organic acid from an organic hydroperoxide stream comprising bringing the hydroperoxide stream into contact with an extraction fluid, whereby the extraction fluid and the hydroperoxide stream are separated from each other by a membrane. In such process, organic acid may be removed preferably by being converted into a salt either in the pores of the membrane or at its surface. Salts will subsequently transfer into the extraction fluid.

### DETAILED DESCRIPTION OF THE INVENTION

Methods for transferring compounds through membranes are known under the acronym “pertraction” which stands for permeation enhanced extraction, which is also known under the term “membrane facilitated extraction.” Pertraction, in general, is a known method. For instance, GB 2,355,455 describes the removal and recovery of phenolic compounds from an aqueous effluent using a non-porous selectively permeable membrane and the mathematical theory behind this process has been described by R. Basu et al., AIChEJ., vol. 36 (3), p. 450-460 (1990). Separation of olefins from a hydrocarbon feed by contacting the mixture with a preferably hydrophobic polymeric, sintered glass, metal, or ceramic ultrafiltration membrane has been disclosed in U.S. Pat. No. 5,107,058. In U.S. Pat. No. 5,095,171 aromatic compounds are separated from non-aromatic compounds by a permeation process through a selective membrane. The pertraction method, however, has never been used or suggested for separating organic acids from an organic hydroperoxide stream.

According to the invention the hydroperoxide stream contains the organic acid. The hydroperoxide stream is preferably non-aqueous. The term “non-aqueous” in this respect means that the hydroperoxide stream contains less than 10% wt of water, preferably less than 5% wt, most preferably less than 2% wt.

According to the invention membrane extraction or pertraction are extraction processes in which the exchanging phases are separated with use of a barrier or membrane. In this way, mixing feed mixture with the extraction fluid is prevented. However, mass-transfer takes place through the pores of the membrane barrier from the feed-side towards the extraction fluid. The membrane comprises hydrophilic or, preferably hydrophobic material (e.g., porous polypropylene available as Celgard or Membrana, both ex Polypore trademarks). For hydrophobic membranes it is preferred to apply a slight pressure on the extraction fluid side in order to facilitate this phase into the pore structure of the membrane. However, this pressure is restricted in order to prevent break-through of the membrane barrier from the extraction fluid side into the organic hydroperoxide side. Preferably, the extraction fluid has a pressure that is 1 bar to 10 bar, more preferably 1.5 bar to 3 bar, higher than the pressure of the hydroperoxide stream. When a hydrophilic membrane is used, such as a membrane of the cellulose type, it is preferred to apply a slight pressure on the hydroperoxide stream. In that case the hydroperoxide stream preferably has a pressure that is 1 bar to 10 bar, more preferably 1.5 bar to 3 bar, higher than the pressure of the extraction fluid.

The membrane may be any hydrophilic or hydrophobic membrane. Hydrophobic membranes are preferred, such as porous polypropylene, polyimide, polysulfone, PVDF (polyvinylidenedifluoride), or PTFE (polytetrafluoroethylene). For reasons of efficiency, hollow fiber membranes are particularly preferred. The hydroperoxide stream and the extraction fluid may be operated in counter-current, co-current, or cross-current mode. For obtaining maximum concentration differences between the hydroperoxide stream and the extraction fluid and obtaining maximum mass transfer the counter-current method is preferred.

The relative pore diameters of the membranes are in the range of 0.1-6 μm, preferably 0.5-2 μm, whereby the pore configurations may have any form, for instance round or slit shaped. The membrane porosity is normally between 70 and 90%. A very high membrane surface area per module volume may be obtained via specific membrane module configurations such as hollow fibers, which accordingly enhances the mass transfer.

An example of a commercially available configuration is, for instance, a membrane surface of 2000 m², which provides a separation of an organic acid from an ethyl benzene hydroperoxide stream at a flow of 300 ton/h and an extraction stream of 25 ton/h, wherein the incoming stream contains 4.10⁻³ weight fraction of acids.

Preferably, the ratio of the flow of the extraction fluid and the flow of the hydroperoxide stream is 1:100 to 1:10, more preferably 1:25 to 3:50.

The membrane facilitates the contact between the extraction fluid and the feed phase without mixing. Additionally, the overall mass-transfer is enhanced due to the large contact area of the membrane, and the chosen extraction fluid determines the eventual selectivity and velocity of the process.

The extraction fluid may be chosen from a wide range of fluids of which someone skilled in the art will understand may be used. The polarity of the extraction fluid will generally be substantially different from the polarity of the organic hydroperoxide stream in order to efficiently remove the acids. In a more preferred embodiment, the extraction fluid is an aqueous solution or water. The aqueous solution preferably comprises base. If a base is present, the organic acid may be converted to a salt by an acid-base reaction. The conversion will generally take place in the pores of the membrane and optionally on its surface. When the acid has been converted to its salt it may be transferred into the aqueous extraction fluid. Thus, a high concentration gradient is maintained for organic acids across the membrane.

The solution preferably contains from 0.01% wt to 10% wt of base, based on total amount of extraction fluid, more specifically from 0.05% wt to 5% wt, preferably from 0.05% wt to 1% wt. The base is preferably selected from sodium hydroxide, potassium hydroxide, sodium carbonate, potassium carbonate, sodium hydrogen carbonate, potassium hydrogen carbonate, and mixtures thereof. Most preferably, the extraction fluid comprises an anion of which the pKb is smaller than the pKa of the organic acid. Furthermore, the pH of the extraction fluid is preferably greater than 7, preferably of from 7.5 to 10, more specifically of from 8 to 10.

The method may be used for the separation of any organic acid from any organic hydroperoxide stream. Preferably, the organic hydroperoxide stream is obtained by oxidation of an organic compound such as ethylbenzene and/or cumene. The oxidation may be carried out in the liquid phase in the presence of a diluent. This diluent is preferably a compound which is liquid under the reaction conditions and does not react with the starting materials and product obtained. However, the diluent may also be a compound necessarily present during the reaction. For example, if the alkylaryl is ethylbenzene the diluent may be ethylbenzene as well and if the alkylaryl is cumene the diluent may be cumene as well. Besides the desired organic hydroperoxide, a range of contaminants are created during the oxidation of organic compounds.

The method of the present invention is particularly useful for separating organic acids such as formic acid, acetic acid, propionic acid, and benzoic acid from an ethyl benzene hydroperoxide or cumene hydroperoxide stream.

1. A method for separating organic acid from an organic hydroperoxide stream comprising: bringing the hydroperoxide stream into contact with an extraction fluid wherein the extraction fluid and the hydroperoxide stream are separated from each other by a membrane.

2. The method of claim 1 wherein the extraction fluid is an aqueous fluid comprising a base.

3. The method of claim 2 wherein the hydroperoxide stream and the extraction fluid are in counter-current flow.

4. The method of claim 2 wherein the base is selected from the group consisting of sodium hydroxide, potassium hydroxide, sodium carbonate, potassium carbonate, sodium hydrogen carbonate, potassium hydrogen carbonate, and mixtures thereof.

5. The method of claim 3 wherein the hydroperoxide stream and the extraction fluid are in counter-current flow.

6. The method of claim 3 wherein the ratio of the flow of the extraction fluid and the flow of the hydroperoxide stream is 1:100 to 1:10.

7. The method of claim 3 wherein organic acid is separated from an ethyl benzene hydroperoxide stream or a cumene hydroperoxide stream.

8. The method of claim 3 wherein the membrane is a hollow fiber membrane.

9. The method of claim 3 wherein a hydrophobic membrane is used and the extraction fluid has a pressure that is 1 bar to 10 bar higher than the pressure of the hydroperoxide stream.

10. The method of claim 3 wherein a hydrophilic membrane is used and the hydroperoxide stream has a pressure that is 1 bar to 10 bar higher than the pressure of the extraction fluid.

11. The method of claim 1 wherein the extraction fluid has a pH of more than 7.

12. The method of claim 1 wherein the hydroperoxide stream and the extraction fluid are in counter-current flow.

13. The method of claim 1 wherein the ratio of the flow of the extraction fluid and the flow of the hydroperoxide stream is 1:100 to 1:10.

14. The method of claim 1 wherein the ratio of the flow of the extraction fluid and the flow of the hydroperoxide stream is 1:25 to 3:50.

15. The method of claim 1 wherein organic acid is separated from an ethyl benzene hydroperoxide stream or a cumene hydroperoxide stream.

16. The method of claim 1 wherein the membrane is a hollow fiber membrane.

17. The method of claim 1 wherein a hydrophobic membrane is used and the extraction fluid has a pressure that is 1 bar to 10 bar higher than the pressure of the hydroperoxide stream.

18. The method of claim 1 wherein a hydrophobic membrane is used and the extraction fluid has a pressure that is 1.5 bar to 3 bar higher than the pressure of the hydroperoxide stream.

19. The method of claim 1 wherein a hydrophilic membrane is used and the hydroperoxide stream has a pressure that is 1 bar to 10 bar higher than the pressure of the extraction fluid.

20. The method of claim 1 wherein a hydrophobic membrane is used and the hydroperoxide stream has a pressure that is 1.5 bar to 3 bar higher than the pressure of the extraction fluid.
